(19) United States
(12) Patent Application Publication
(10) Pub. No.: US 2013/0205034 A1
(43) Pub. Date: Aug. 8, 2013

(54) METHODS FOR FACILITATING COMMUNICATIONS IN A PRESENCE AND MESSAGING SERVER AND DEVICES THEREOF

(71) Applicants: Sudhir KAKKAR, Chennai (IN); Srinath Badrinath, Chennai (IN); Vivek SELLAPPAN, Namakkal (IN)

(72) Inventors: Sudhir KAKKAR, Chennai (IN); Srinath Badrinath, Chennai (IN); Vivek SELLAPPAN, Namakkal (IN)

(73) Assignee: INFOSYS LIMITED, Bangalore (IN)

(21) Appl. No.: 13/495,163

(22) Filed: Jun. 13, 2012

(30) Foreign Application Priority Data
Feb. 6, 2012 (IN) 420/CHE/2012

(51) Int. Cl. G06F 15/16

(52) U.S. Cl. 709/228

(57) ABSTRACT

A method, non-transitory computer readable medium, and apparatus for facilitating communication of presence information includes establishing a connection with at least one client computing device upon receiving a request for presence information from the client computing device. The request for presence information is inserted into a first queue. A response message is asynchronously obtained from a second queue maintained by a session server. The response message is sent to the client computing device according to the established connection.

This application claims the benefit of Indian Patent Application Filing No. 420/CHE/2012, filed Feb. 6, 2012, which is hereby incorporated by reference in its entirety.

### FIELD

This technology generally relates to methods and devices for facilitating communications in a presence and messaging server and, more particularly, for highly scalable methods for facilitating reliable communications between layers, logical units, and/or servers of a presence and messaging server system.

### BACKGROUND

A presence and messaging server system may collect, store, manage, and/or distribute presence information corresponding to a very large number of associated clients, such as through subscribe events, and may provide functions relating to presence, availability, and/or communication between clients. Presence information can include contact information, data that indicates whether a user is available in a particular location or via a particular communications device, information required to establish chat, instant message, and/or other sessions for communication, and/or information necessary to track, locate, contact and/or communicate with other clients of the presence and messaging server. A presence and messaging server system may provide publication and/or notification capabilities, which allow a client to subscribe to the availability data, or other type of data, of one or more other clients and receive notifications in real-time, or near real-time, of changes to the status of the associated presence information for the subscribed-to client.

Due in part to the volume of communications handled by a presence and messaging server system, performance, in terms of reliability, response time, message delivery, and/or scalability, for example, is an important consideration for any presence and messaging server deployment. However, current presence and messaging server systems lack scalability, provide limited resources in periods of peak traffic or high congestion, due at least in part to synchronous processing, and provide unreliable service.

### SUMMARY

A method for facilitating communication of presence information includes establishing, with a connection server, a connection with at least one client computing device upon receiving a request for presence information from the client computing device. The request for presence is inserted with the connection server information into a first queue. A response message the requested presence information is asynchronously obtained with the connection server from a second queue maintained by a session server. The response message is sent with the connection server to the client computing device according to the established connection.

A non-transitory computer readable medium having stored thereon instructions for facilitating communication of presence information comprising machine executable code which when executed by at least one processor, causes the processor to perform steps including establishing a connection with at least one client computing device upon receiving a request for presence information from the client computing device. The request for presence information is inserted into a first queue. A response message including the requested presence information is asynchronously obtained from a second queue maintained by a session server. The response message is sent to the client computing device according to the established connection.

A connection server computing apparatus includes one or more processors, a memory coupled to the one or more processors which are configured to execute programmed instructions stored in the memory including establishing a connection with at least one client computing device upon receiving a request for presence information from the client computing device. The request for presence information is inserted into a first queue. A response message including the requested presence information is asynchronously obtained from a second queue maintained by a session server. The response message is sent to the client computing device according to the established connection.

A method for facilitating communication of presence information includes asynchronously obtaining with a session server a request for presence information from a first queue maintained by a connection server. The requested presence information is received with the session server from one or more database servers. A response message including the requested presence information is inserted with the session server into a second queue maintained by the session server.

A non-transitory computer readable medium having stored thereon instructions for facilitating communication of presence information comprising machine executable code which when executed by at least one processor, causes the processor to perform steps including asynchronously obtaining request for presence information from a first queue maintained by a connection server. The requested presence information is received from one or more database servers. A response message including the requested presence information is inserted into a second queue maintained by the session server.

A session server computing apparatus includes one or more processors, a memory coupled to the one or more processors which are configured to execute programmed instructions stored in the memory including asynchronously obtaining request for presence information from a first queue maintained by a connection server. The requested presence information is received from one or more database servers. A response message including the requested presence information is inserted into a second queue maintained by the session server.

This technology provides a number of advantages including providing more efficient methods, non-transitory computer readable medium, and devices for facilitating communications in a presence and messaging server by providing an asynchronous and staged event-driven architecture (SEDA) with at least a connection server and a session server connected by queues. With this technology, loosely coupled distributed applications provide more reliable service to clients communicating with the presence and messaging server. Additionally, the architecture is more scalable and capable of providing more reliable service to more clients concurrently communicating with the presence and messaging server and in periods of heavy load.

### BRIEF DESCRIPTION OF THE DRAWINGS

FIG. 1 is an environment with an exemplary presence and messaging server system;

FIG. 2 is a flow chart of an exemplary method for facilitating communications in a presence and messaging server system; and

FIG. 3 is a flow chart of an exemplary method for facilitating communications in a presence and messaging server system.

### DETAILED DESCRIPTION

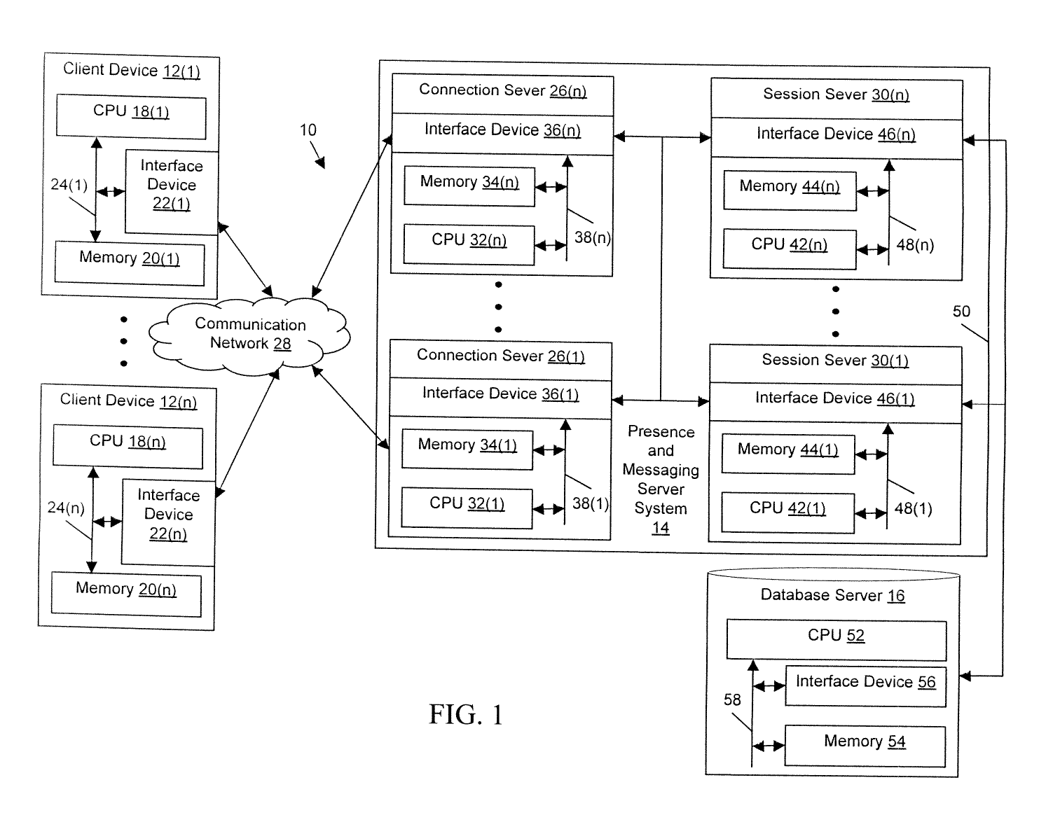

An environment 10 with an exemplary presence and messaging server system 14 is illustrated in FIG. 1. The environment 10 includes client devices 12(1)-12(n), a presence and messaging server system 14, and a database server 16, although the environment 10 can include other types and numbers of components, devices, systems, and other elements in other configurations. This technology provides a number of advantages including providing more effective methods and devices for facilitating communications in a presence and messaging server 14 in order to improve the reliability, scalability, and performance of the presence and messaging server 14.

The client devices 12(1)-12(n) each include a central processing unit (CPU) 18(1)-18(n) or processor, a memory 20(1)-20(n), and an interface 22(1)-22(n) or I/O system, which are coupled together by a bus 24(1)-24(n) or other link, although each could include other numbers and types of devices, elements, and components in other configurations. The client devices 12(1)-12(n) are coupled to the presence and messaging server system 14, and more specifically one or more of the connection servers 26(1)-26(n), by one or more communication networks 28, such as a wide area network, in order to facilitate storage and/or retrieval of presence information, for example, although this environment 10 can include other numbers and types of systems, devices, components, and elements in other configurations, such as multiple numbers of each of these apparatuses and devices. The client devices 12(1)-12(n) can communicate with the connection servers 26(1)-26(n) using any suitable interface mechanism and communications technology, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

In one example, the presence and messaging server system 14 includes one or more connection servers 26(1)-26(n) in communication with one or more session servers 30(1)-30(n). The connection servers 26(1)-26(n) and session servers 30(1)-30(n) can be application servers, such as Java 2, Enterprise Edition (J2EE) platform application servers. In another example, the presence and messaging server system 14 includes one or more application servers in which the connection servers and session servers are layers or logical units, for example, although the presence and messaging server system 14 can include other numbers and types of servers, logical units, components, and elements in other configurations, such as multiple numbers of each of these apparatuses and devices.

The connection servers 26(1)-26(n) each include at least one CPU 32(1)-32(n), a memory 34(1)-34(n), and an interface 36(1)-36(n) or I/O system, which are coupled together by a bus 38(1)-38(n) or other link, although each could include other numbers and types of devices, elements, and components in other configurations. The connection servers 26(1)-26(n) can communicate with the session servers 30(1)-30(n) over a network link 40 such as a local area network (LAN).

The processor 32(1)-32(n) in the connection servers 26(1)-26(n) can execute a program of stored instructions for establishing and maintaining connections with the client devices 12(1)-12(n), including validation of messages received from client devices 12(1)-12(n), and asynchronously communicating with the session servers 30(1)-30(n), for example. The memory 34(1)-34(n) in the connection servers 26(1)-26(n) stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the apparatus or a floppy disk, hard disk, CD ROM, DVD ROM, or other computer readable medium which is read from and written to by a magnetic, optical, or other reading and writing system that is coupled to the processors 32(1)-32(n), can be used for the memory 34(1)-34(n).

The session servers 30(1)-30(n) each include at least one CPU 42(1)-42(n), a memory 44(1)-44(n), and an interface 46(1)-46(n) or I/O system, which are coupled together by a bus 48(1)-48(n) or other link, although each could include other numbers and types of devices, elements, and components in other configurations.

The processor 42(1)-42(n) in the session servers 30(1)-30(n) can execute a program of stored instructions for communicating with the database server 16 over network link 48 to store and/or retrieve presence information stored therein and for asynchronously communicating with the connection servers 26(1)-26(n), for example. The memory 44(1)-44(n) in the session servers 30(1)-30(n) stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the apparatus or a floppy disk, hard disk, CD ROM, DVD ROM, or other computer readable medium which is read from and written to by a magnetic, optical, or other reading and writing system that is coupled to the processors 42(1)-42(n), can be used for the memory 44(1)-44(n).

The database server 16 includes at least one CPU 52 or processor, a memory 54, and an interface 56 or I/O system, which are coupled together by a bus 58 or other link, although the database server 16 could include other numbers and types of devices, elements, and components in other configurations. In one example the database server 16 is a SQL server including SQL code defining one or more relational databases and stores presence information in the relational databases. The processor 52 in the database server 16 can execute a program of stored instructions including a database management system (DBMS) for facilitating storing and retrieval of presence information and/or any other database service, for example. The memory 54 in the database server 16 stores these programmed instructions, although some or all of the programmed instructions could be stored and executed elsewhere. Additionally, any number and type of database server 16, or any other computing device capable of storing and responding to requests for information, can be provided in the environment 10.

It is to be understood that the devices and systems of the examples described herein are for exemplary purposes, as many variations of the specific hardware and software used to implement the examples are possible, as will be appreciated by those skilled in the relevant art(s). Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

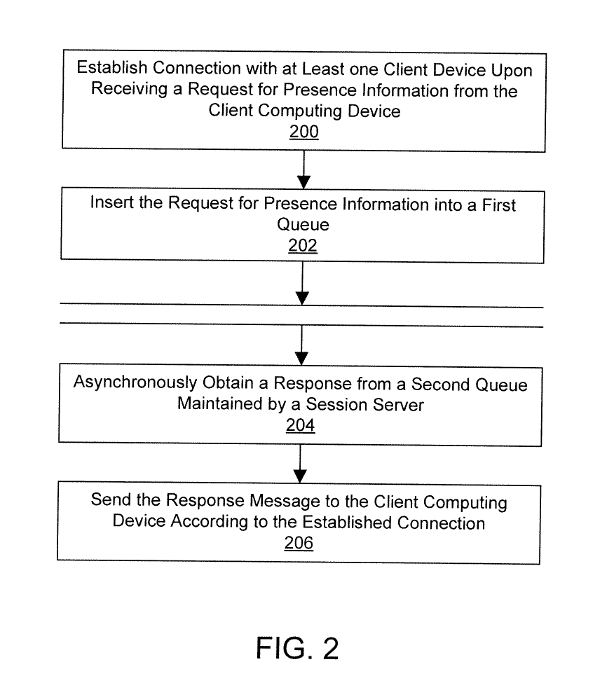

An exemplary method for facilitating communication of presence information will now be described with reference to FIGS. 1-3. In step 200, one of the connection servers 26(1)-26(n) establishes a connection with at least one client computing device 12(1)-12(n) in response to a request for presence information received from the client computing device 12(1)-12(n) over communication network 28. The request for presence information can be a request for network availability of another client computing device 12(1)-12(n), for example. Optionally, the connection server 26(1)-26(n) stores identifying information regarding the connection and/or the client computing device 12(1)-12(n) that initiated the connection in memory 34(1)-34(n). Also optionally, the connection server 26(1)-26(n) performs some processing on the request, such as validation.

In step 202, the request, optionally at least partially processed, is inserted by the connection server 26(1)-26(n) into a first queue. The first queue can be stored in the memory 34(1)-34(n), for example.

In step 204, the connection server 26(1)-26(n) asynchronously obtains a response message including the requested information from a second queue maintained by one of the session servers 30(1)-30(n). The retrieval of the response message is asynchronous in that the connection server 26(1)-26(n) may retrieve any number of response messages from the second queue in the order of their insertion, and prior to dequeuing a message response to the current request for presence information, and the retrieval of a response message from the second queue is not initiated by the enqueue of a response message by one of the session server 30(1)-30(n), or any other activity of the session servers 30(1)-30(n), but instead is determined by the availability of the connection server 26(1)-26(n) and associated current load. Additionally, subsequent or parallel to insertion of the request in the first queue at step 200, the connection server 26(1)-26(n) can receive a subsequent request for information message from the same or another client computing device 12(1)-12(n) and place it in the first queue without receiving any response from the session server 30(1)-30(n) to any prior request placed in the first queue.

In step 206, the connection server 26(1)-26(n) sends the response message including the requested presence information to the client computing device 12(1)-12(n) according to the connection established in step 200.

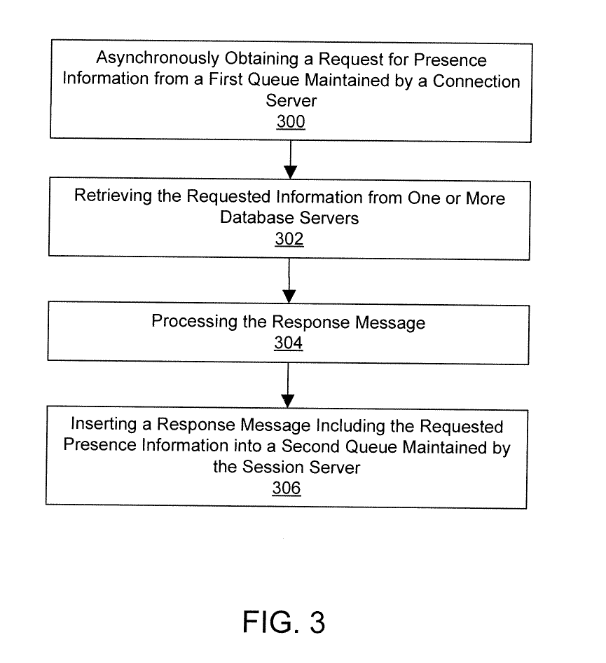

Referring to FIG. 3, in parallel to the activities of the connection servers 26(1)-26(n), at least one of the session servers 30(1)-30(n) asynchronously obtains, at step 300, a request for presence information from the first queue maintained by one of the connection server 26(1)-26(n), as previously inserted in step 202 described above. The retrieval of the request is asynchronous in that the session server 30(1)-30(n) may retrieve any number of requests from the first queue in the order of their insertion, and prior to dequeuing the current request, and the retrieval of a request for information message from the first queue is not necessarily initiated by the enqueue of the current request by the connection server 26(1)-26(n), or any other activity of the connection server 26(1)-26(n), but instead is determined by the availability of the session server 30(1)-30(n) and associated current load.

In step 302, the session server 30(1)-30(n) retrieves the presence information referenced by the request for presence information, obtained from the first queue at step 300, from the database server 16.

The session server 30(1)-30(n) then prepares a response message including the requested presence information and optionally performs some processing on the response message, at step 304, such as by transforming the message, validating the message, and/or encrypting the message.

The response message, optionally at least partially processed, is then inserted, at step 306, by the session server 30(1)-30(n) into a second queue. The second queue can be stored in the memory 44(1)-44(n), for example. Additionally, subsequent or parallel to insertion of the response message into the second queue, the session server 30(1)-30(n) can obtain a subsequent request for presence information from the first queue, at step 300, without any response message being retrieved, at step 204, from the second queue by a connection server 26(1)-26(n).

Accordingly, the connection functionality is loosely coupled to the session and information retrieval functionality of the presence and messaging server system 14 thereby increasing reliability of processing numerous requests for presence information and numerous response messages. In high traffic periods, each of the connection servers 26(1)-26(n) and session servers 30(1)-30(n) are able to buffer messages using queues and the increased activity of one server (e.g. a session server 30(1)-30(n) when retrieving a large data file from the database server 16) does not inhibit the activity of any other server, thereby decreasing the likelihood of dropped messages and/or unreliable service as well as increasing scalability.

In one example, the connection servers 26(1)-26(n) and the session servers 30(1)-30(n) communicate based on the Java Message Service (JMS) application programming interface (API) and the first and second queues are JMS queues.

In this example, in order for the connection server 26(1)-26(n) to insert the request for presence information into the first JMS queue at step 202, the connection server 26(1)-26(n) uses a JMS producer object associated with the first JMS queue and created by a session object which is created by a connection object instantiated by the connection server 26(1)-26(n). The JMS producer object can also identify the appropriate JMS producer to handle the current request for information message based on information contained in the request such as header or body information, for example.

In order for the connection server 26(1)-26(n) to asynchronously obtain a response message from the second JMS queue at step 204, the connection server 26(1)-26(n) uses a message listener object registered to a message consumer object associated with the second JMS queue.

In order for the session server 30(1)-30(n) to asynchronously obtain the request for presence information at step 300, the session server 30(1)-30(n) uses a message listener object registered to a message consumer object associated with the first JMS queue.

Subsequent to retrieving the requested information from the database at step 204, and in order for the session server 30(1)-30(n) to insert the response message into the second JMS queue, at step 304, the session server 30(1)-30(n) uses a JMS producer object associated with the second JMS queue and created by a session object which is created by a connection object instantiated by the session server 30(1)-30(n).

Accordingly, as illustrated and described with the examples herein, this technology facilitates communication of presence information among servers and/or layers or logical units of a presence and messaging server system to increase reliability and provide a scalable architecture for handling a large number of communications requesting and providing presence information. By establishing asynchronously-communicating servers for performing specific functions of a distributed presence application, messages will be more likely to be delivered as intended and an increased number of clients can be serviced with reduced infrastructure.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating communication of presence information, comprising:
establishing, with a connection server, a connection with at least one client computing device upon receiving a request for presence information from the client computing device;
inserting, with the connection server, the request for presence information into a first queue;
asynchronously obtaining, with the connection server, a response message including the requested presence information from a second queue maintained by a session server; and
sending, with the connection server, the response message to the client computing device according to the established connection.

2. The method as set forth in claim 1 wherein:
the connection server and the session server communicate based on the Java Message Service (JMS) application programming interface (API);
the first and second queues are JMS queues;
the request for presence information is inserted into the first JMS queue using a JMS producer object; and
the response message is obtained using a message listener object registered to a message consumer object associated with the second JMS queue.

3. The method as set forth in claim 1 wherein the connection server further comprises a plurality of connection servers comprising a connection server cluster.

4. A non-transitory computer readable medium having stored thereon instructions for facilitating communication of presence information comprising machine executable code which when executed by at least one processor, causes the processor to perform steps comprising:
establishing a connection with at least one client computing device upon receiving a request for presence information from the client computing device;
inserting the request for presence information into a first queue;
asynchronously obtaining a response message including the requested presence information from a second queue maintained by a session server; and
sending the response message to the client computing device according to the established connection.

5. The medium as set forth in claim 4 wherein:
the connection server and the session server communicate based on the Java Message Service (JMS) application programming interface (API);
the first and second queues are JMS queues;
the request for presence information is inserted into the first JMS queue using a JMS producer object; and
the response message is obtained using a message listener object registered to a message consumer object associated with the second JMS queue.

6. The medium as set forth in claim 4 wherein the connection server further comprises a plurality of connection servers comprising a connection server cluster.

7. A connection server computing apparatus for facilitating communication of presence information comprising:
one or more processors; and
a memory coupled to the one or more processors which are configured to execute programmed instructions stored in the memory comprising:
establishing a connection with at least one client computing device upon receiving a request for presence information from the client computing device;
inserting the request for presence information into a first queue;
asynchronously obtaining a response message including the requested presence information from a second queue maintained by a session server; and
sending the response message to the client computing device according to the established connection.

8. The apparatus as set forth in claim 7 wherein:
the connection server and the session server communicate based on the Java Message Service (JMS) application programming interface (API);
the first and second queues are JMS queues;
the request for presence information is inserted into the first JMS queue using a JMS producer object; and
the response message is obtained using a message listener object registered to a message consumer object associated with the second JMS queue.

9. The apparatus as set forth in claim 7 wherein the connection server further comprises a plurality of connection servers comprising a connection server cluster.

10. A method for facilitating communication of presence information, comprising:
asynchronously obtaining, with a session server, a request for presence information from a first queue maintained by a connection server;
retrieving, with the session server, the requested presence information from one or more database servers; and
inserting, with the session server, a response message including the requested presence information into a second queue maintained by the session server.

11. The method as set forth in claim 10 wherein;
the connection server and the session server communicate based on the Java Message Service (JMS) application programming interface (API).
the first and second queues are JMS queues;
the response message is inserted into the second JMS queue using a JMS producer object; and
the request for presence information is obtained using a message listener object registered to a message consumer object associated with the first JMS queue

12. The method as set forth in claim 10 wherein the session server further comprises a plurality of session servers comprising a session server cluster.

13. The method as set forth in claim 10 further comprising prior to inserting the response message into the second queue, processing, with the session server, the response message wherein the processing further comprises at least one of transforming the message, validating the message, or encrypting the message.

14. A non-transitory computer readable medium having stored thereon instructions for facilitating communication of presence information comprising machine executable code which when executed by at least one processor, causes the processor to perform steps comprising:
asynchronously obtaining a request for presence information from a first queue maintained by a connection server;
retrieving the requested presence information from one or more database servers; and
inserting a response message including the requested presence information into a second queue maintained by the session server.

15. The medium as set forth in claim 14 wherein:
the connection server and the session server communicate based on the Java Message Service (JMS) application programming interface (API).
the first and second queues are JMS queues;
the response message is inserted into the second JMS queue using a JMS producer object; and
the request for presence information is obtained using a message listener object registered to a message consumer object associated with the first JMS queue

16. The medium as set forth in claim 14 wherein the session server further comprises a plurality of session servers comprising a session server cluster.

17. The medium as set forth in claim 14 further having stored thereon instructions for facilitating communication of presence information comprising machine executable code which when executed by the at least one processor, causes the processor to perform steps further comprising prior to inserting the response message into the second queue, processing the response message wherein the processing further comprises at least one of transforming the message, validating the message, or encrypting the message.

18. A session server computing apparatus for facilitating communication of presence information comprising:
one or more processors; and
a memory coupled to the one or more processors which are configured to execute programmed instructions stored in the memory comprising:
asynchronously obtaining a request for presence information from a first queue maintained by a connection server;
retrieving the requested presence information from one or more database servers; and
inserting a response message including the requested presence information into a second queue maintained by the session server.

19. The apparatus as set forth in claim 18 wherein:
the connection server and the session server communicate based on the Java Message Service (JMS) application programming interface (API).
the first and second queues are JMS queues;
the response message is inserted into the second JMS queue using a JMS producer object; and
the request for presence information is obtained using a message listener object registered to a message consumer object associated with the first JMS queue

20. The apparatus as set forth in claim 18 wherein the session server further comprises a plurality of session servers comprising a session server cluster.

21. The apparatus as set forth in claim 18 wherein the memory coupled to the one or more processors is further configured to execute programmed instructions stored in the memory further comprising prior to inserting the response message into the second queue, processing the response message wherein the processing further comprises at least one of transforming the message, validating the message, or encrypting the message.
